(19) United States
(12) Patent Application Publication
(10) Pub. No.: US 2026/0027835 A1
(43) Pub. Date: Jan. 29, 2026

(54) FILTER UNIT, LIQUID EJECTING APPARATUS, AND MAINTENANCE METHOD FOR LIQUID EJECTING HEAD

(71) Applicant: SEIKO EPSON CORPORATION, Tokyo (JP)

(72) Inventors: Keita MORIYAMA, MATSUMOTO-SHI (JP); Hidenori SOKABE, SHIOJIRI-SHI (JP)

(21) Appl. No.: 19/277,618

(22) Filed: Jul. 23, 2025

(30) Foreign Application Priority Data
Jul. 26, 2024 (JP) 2024-121380

(51) Int. Cl. B41J 2/175; B41J 2/17

(52) U.S. Cl. CPC B41J 2/17563; B41J 2/1707

(57) ABSTRACT

Provided is a filter unit used in a posture in which a gravity direction and a virtual plane extending along a filter intersect each other, the filter unit including the filter, a filter chamber that includes an upstream chamber and a downstream chamber separated by the filter, an inlet for introduction of liquid, and an outlet through which the liquid flows out via the downstream chamber. The inlet is open in a second direction that intersects a first direction perpendicular to the virtual plane extending along the filter, the outlet is open in a third direction opposite to the second direction, and the inlet overlaps with the outlet as seen in the third direction.

The present application is based on, and claims priority from JP Application Serial Number 2024-121380, filed Jul. 26, 2024, the disclosure of which is hereby incorporated by reference herein in its entirety.

### BACKGROUND

### 1. Technical Field

The present disclosure relates to a filter unit in which a filter for removal of foreign substances contained in liquid is provided, a liquid ejecting apparatus including a filter unit and a liquid ejecting head that ejects liquid supplied from the filter unit, and a maintenance method for a liquid ejecting head that ejects liquid supplied from a filter chamber.

### 2. Related Art

A liquid ejecting apparatus includes a liquid ejecting head that ejects droplets of liquid, such as ink supplied from a liquid storage portion like an ink tank, through a plurality of nozzles by means of a change in pressure caused by a pressure generating unit. In addition, the liquid ejecting apparatus includes a filter unit that includes a flow path for supply of ink from the liquid storage portion to the liquid ejecting head and a filter chamber provided with a filter that is provided at an intermediate portion of the flow path and that captures foreign substances, such as dust and air bubbles contained in liquid (for example, refer to JP-A-2022-101347).

In the case of such a filter unit, it is desired to easily discharge air bubbles in the filter chamber at the time of an initial filling operation of initially filling the liquid ejecting head with liquid from the liquid storage portion via the filter chamber or a cleaning operation of discharging the air bubbles staying in the filter chamber.

### SUMMARY

According to an aspect of the present disclosure, there is provided a filter unit used in a posture in which a gravity direction and a virtual plane extending along a filter intersect each other, the filter unit including the filter, a filter chamber that includes an upstream chamber and a downstream chamber separated by the filter, an inlet for introduction of liquid from an outside of the filter unit, and an outlet through which the liquid in the filter chamber flows out to the outside of the filter unit via the downstream chamber, in which the inlet is open in a second direction that intersects a first direction perpendicular to the virtual plane extending along the filter, the outlet is open in a third direction opposite to the second direction, and the inlet overlaps with the outlet as seen in the third direction.

According to another aspect of the present disclosure, there is provided a liquid ejecting apparatus including a liquid ejecting head that ejects liquid, a liquid storage portion that stores the liquid to be supplied to the liquid ejecting head, and the filter unit described above, the filter unit being disposed at an intermediate portion of a supply flow path for supply of the liquid from the liquid storage portion to the liquid ejecting head.

According to still another aspect of the present disclosure, there is provided a maintenance method for a liquid ejecting head that includes a plurality of nozzles for ejection of liquid supplied from a filter chamber including an upstream chamber and a downstream chamber separated by a filter, the maintenance method including performing a printing operation in which the liquid ejecting head ejects the liquid to a medium with the filter chamber being in a first posture in which a lower surface of the filter that defines the downstream chamber faces a gravity direction and performing maintenance in which the liquid is discharged to an outside from the plurality of nozzles via the filter chamber with the filter chamber being in a second posture in which the lower surface faces a direction opposite to the gravity direction.

### BRIEF DESCRIPTION OF THE DRAWINGS

FIG. 1 is a view showing a schematic configuration of a liquid ejecting apparatus according to Embodiment 1 of the present disclosure.

FIG. 2 is a schematic view of the liquid ejecting apparatus according to Embodiment 1 of the present disclosure.

FIG. 3 is a cross-sectional view of a filter unit according to Embodiment 1 of the present disclosure.

FIG. 4 is a cross-sectional view of the filter unit according to Embodiment 1 of the present disclosure.

FIG. 5 is a functional block diagram of the liquid ejecting apparatus according to Embodiment 1 of the present disclosure.

FIG. 6 is a cross-sectional view of a filter unit according to Embodiment 2 of the present disclosure.

FIG. 7 is a cross-sectional view of a filter unit according to Embodiment 3 of the present disclosure.

FIG. 8 is a plan view of a main portion of the filter unit according to Embodiment 3 of the present disclosure.

FIG. 9 is a cross-sectional view of a filter unit according to Embodiment 4 of the present disclosure.

### DESCRIPTION OF EMBODIMENTS

The present disclosure will be described in detail below based on embodiments. However, the following description merely shows one embodiment of the present disclosure, and can be modified as desired within the scope of the present disclosure. In each drawing, the same reference numerals indicate the same members, and the description thereof will be omitted as appropriate. In addition, in each drawing, X, Y, and Z represent three spatial axes that are orthogonal to each other. In the present specification, directions along these axes will be referred to as X directions, Y directions, and Z directions. In each drawing, a direction indicated by an arrow is a positive (+) direction, and a direction opposite to the arrow is a negative (−) direction. In addition, the Z direction is a vertical direction, a +Z direction is a gravity direction, that is, a vertical downward direction, and a-Z direction is a direction opposite to the gravity direction, that is, a vertical upward direction. Furthermore, directions along the three spatial axes of which the positive direction and the negative direction are not limited will be referred to as an X-axis direction, a Y-axis direction, and a Z-axis direction.

### Embodiment 1

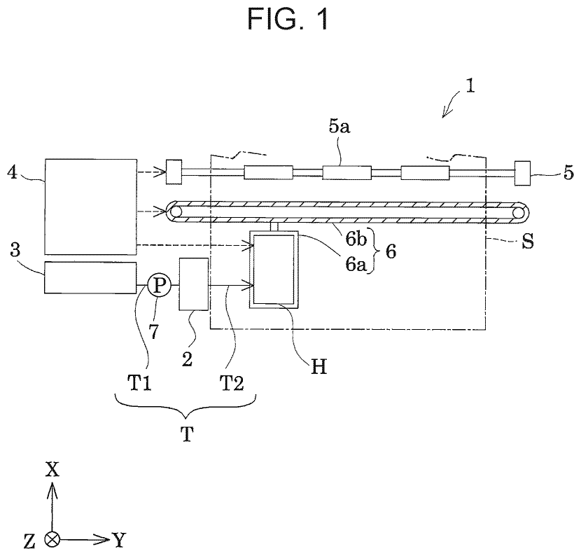

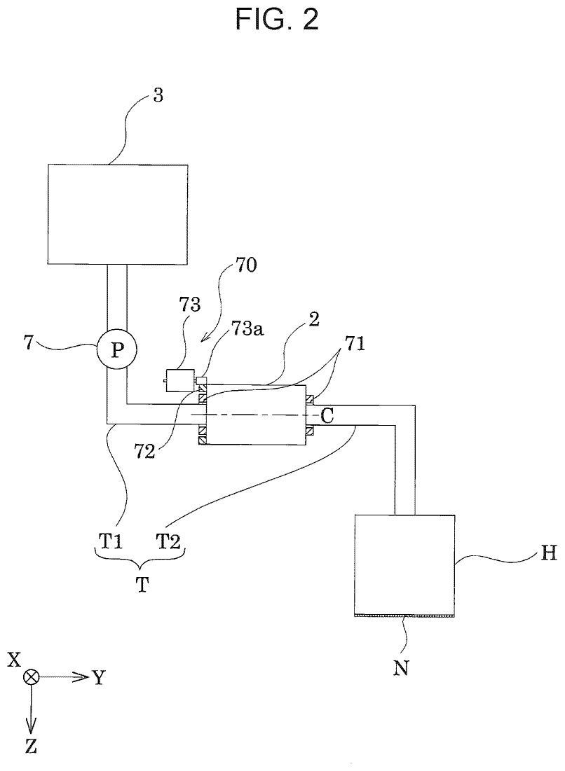

FIG. 1 is a view showing a schematic configuration of a liquid ejecting apparatus 1 according to the present disclosure. FIG. 2 is a schematic view of a liquid storage portion 3, a filter unit 2, and a liquid ejecting head H.

As shown in the drawing, the liquid ejecting apparatus 1 is a so-called serial type printer that includes the liquid ejecting head H and that performs printing by ejecting (discharging) liquid toward a medium S from the liquid ejecting head H in the +Z direction while transporting the medium S in the X-axis direction and causing the liquid ejecting head H to reciprocate in the Y-axis direction. Note that as the medium S, any material, such as a resin film or cloth, can be used instead of recording paper.

The liquid ejecting apparatus 1 includes the liquid ejecting head H, the filter unit 2, the liquid storage portion 3, a control device 4, a transportation mechanism 5 that feeds the medium S, and a movement mechanism 6.

The liquid ejecting head H ejects droplets of liquid supplied from the liquid storage portion 3 in the +Z direction.

The liquid storage portion 3 individually stores a plurality of types of inks that have different colors or different components and are ejected from the liquid ejecting head H. Examples of the liquid storage portion 3 include a cartridge that is attachable and detachable to and from the liquid ejecting apparatus 1, a bag-shaped ink pack made of a flexible film, and an ink tank that can be replenished with ink. Note that FIG. 1 shows one liquid storage portion 3. Incidentally, the liquid storage portion 3 may be a liquid storage portion 3 including separated rooms for individual storage of a plurality of types of ink or may be a plurality of liquid storage portions 3 individually provided corresponding to the plurality of types of ink. In addition, the liquid storage portion 3 may be divided into a main tank and a sub tank. A configuration in which the sub tank is coupled to the liquid ejecting head H and the sub tank is replenished with ink from the main tank as compensation for consumption of ink attributable to ink ejection from the liquid ejecting head H may also be adopted.

A supply tube T is coupled to the liquid storage portion 3. Although one supply tube T is shown in FIG. 1, the supply tube T is provided for each of different types of ink.

The supply tube T is a tube through which ink in the liquid storage portion 3 that is pressurized by a pump 7 such that the pressure thereof becomes a predetermined pressure is supplied to the liquid ejecting head H via the filter unit 2.

The control device 4 includes, for example, a control device such as a central processing unit (CPU) or a field programmable gate array (FPGA), and a storage device such as a semiconductor memory. In addition, the control device 4 also includes a power supply device that supplies, to each element of the liquid ejecting apparatus 1, power supplied from an external power source, such as a commercial power source. The control device 4 is electrically coupled to the liquid ejecting head H via an external wire (not shown). The control device 4 comprehensively controls each element of the liquid ejecting apparatus 1 with the control device executing a program stored in the storage device.

The transportation mechanism 5 transports the medium S in the X-axis direction, and includes, for example, a transportation roller 5a that is rotated by a transportation motor that is driven under the control of the control device 4.

The movement mechanism 6 is a mechanism for reciprocation of the liquid ejecting head H in the Y-axis direction, and includes a holding body 6a that holds the liquid ejecting head H and a transportation belt 6b that is an endless belt installed along the Y-axis direction. The control device 4 controls the driving of a transportation motor (not shown) such that the transportation belt 6b rotates and the liquid ejecting head H reciprocates in the Y-axis direction together with the holding body 6a fixed to the transportation belt 6b. Note that the filter unit 2 can be mounted to the holding body 6a together with the liquid ejecting head H. In addition, the liquid storage portion 3 can be mounted to the holding body 6a together with the liquid ejecting head H and the filter unit 2. In addition, although the holding body 6a holds one liquid ejecting head H, the holding body 6a may hold two or more liquid ejecting heads H.

Under the control of the control device 4, the liquid ejecting head H performs a discharging operation of discharging, from each of a plurality of nozzles N, droplets of ink supplied from the liquid storage portion 3 in the +Z direction. The control device 4 functions as a discharge controller controlling discharge of ink that is performed by the liquid ejecting head H. The discharging operation performed by the liquid ejecting head H is performed in parallel with transportation of the medium S in the X-axis direction that is performed by the transportation mechanism 5 and reciprocation of the liquid ejecting head H in the Y-axis direction that is caused by the movement mechanism 6, so that so-called printing, in which ink is applied to the medium S, is performed.

The filter unit 2 captures foreign substances such as dust and air bubbles contained in the ink supplied from the liquid storage portion 3 and supplies the ink to the liquid ejecting head H. That is, the filter unit 2 is disposed between the liquid storage portion 3 and the liquid ejecting head H. In the present embodiment, a portion of the supply tube T that is between the liquid storage portion 3 and the filter unit 2 will be referred to as a supply tube T1 and a portion of the supply tube T that is between the filter unit 2 and the liquid ejecting head H will be referred to as a supply tube T2.

A plurality of the filter units 2 are provided corresponding to the types of ink stored in the liquid storage portion 3. FIGS. 1 and 2 show one filter unit 2. In addition, although one filter unit 2 is provided for one type of ink, two or more filter units 2 may be provided for one type of ink with division of the same type of ink, for example.

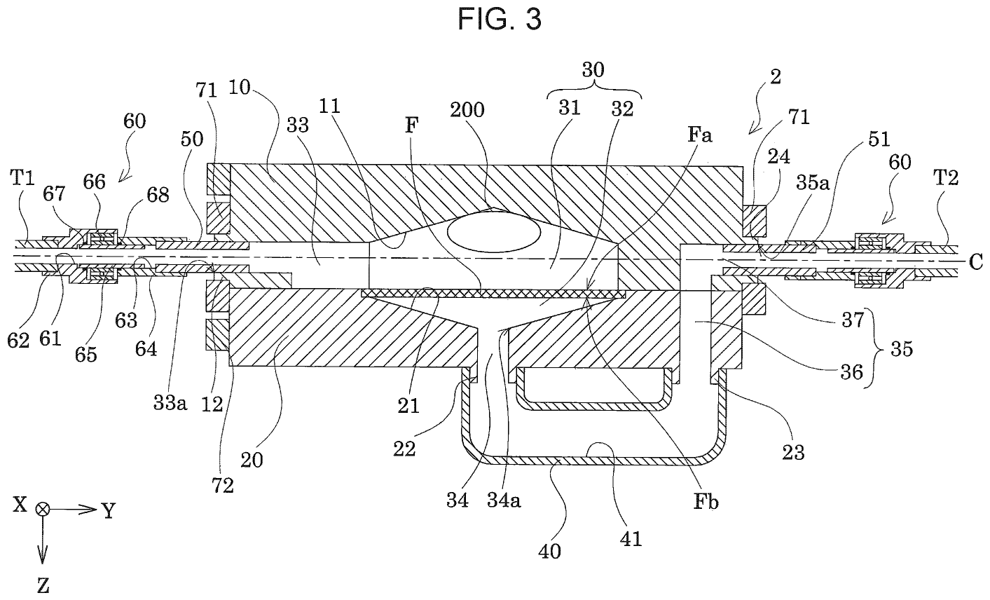

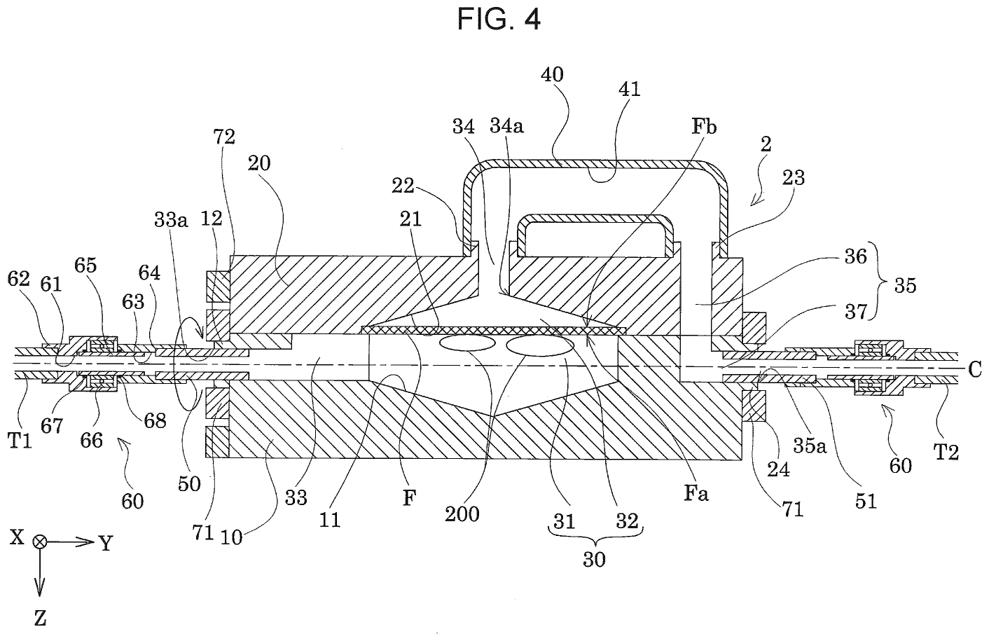

FIG. 3 is a cross-sectional view showing a first posture of the filter unit 2 at the time of printing. FIG. 4 is a cross-sectional view showing a second posture of the filter unit 2 at the time of cleaning. Hereinafter, the configuration of the filter unit 2 will be described by using the X-axis direction, the Y-axis direction, and the Z-axis direction based on the posture at the time of printing which is shown in FIG. 3.

As shown in FIG. 3, the filter unit 2 includes a first flow path member 10 and a second flow path member 20. The first flow path member 10 and the second flow path member 20 are stacked on each other along the Z-axis direction, and the first flow path member 10 is disposed in the −Z direction with respect to the second flow path member 20.

A filter chamber 30 is defined in the filter unit 2. The filter chamber 30 is formed by aligning openings of a first recess portion 11 that is provided at the first flow path member 10 and that is open at a surface facing the +Z direction and a second recess portion 21 that is provided at the second flow path member 20 and that is open at a surface facing the −Z direction. Note that the volume of the first recess portion 11 is larger than the volume of the second recess portion 21.

A filter F is fixed to an opening portion of the second recess portion 21 of the second flow path member 20. The filter F is disposed such that an in-plane direction of a main surface Fa (may also be referred to as an upper surface Fa), in which the filter F extends, is a direction orthogonal to the Z-axis direction, which is a direction in which the first flow path member 10 and the second flow path member 20 are stacked, that is, a direction along an XY plane defined by an X-axis and a Y-axis. That is, a lower surface Fb of the filter F is disposed to face the +Z direction. Such a filter F captures foreign substances such as air bubbles and dust contained in ink, and for example, a sheet-shaped filter that is obtained by finely knitting metal or resin fibers so that a plurality of fine holes are formed can be used. In addition, as the filter F, a filter obtained by providing a plurality of fine through-holes in a plate-shaped member formed of metal or resin can also be used. Furthermore, the filter F may be made of a nonwoven fabric or the like, and the material thereof is not particularly limited. In addition, a method of fixing the filter F to the second flow path member 20 is not particularly limited, and examples thereof include bonding the filter F to the second flow path member 20 with an adhesive, thermal welding, and the like.

The filter chamber 30 is divided by the filter F into an upstream chamber 31 upstream of the filter F and a downstream chamber 32 downstream of the filter F. That is, the upstream chamber 31 is defined by the upper surface Fa of the filter F. In addition, the downstream chamber 32 is defined by the lower surface Fb of the filter F. As seen in the Z-axis direction, each of the filter chamber 30 and the filter F has a circular shape, a so-called rounded rectangular shape (also called a track shape) which is a rectangular shape of which both end portions in a longitudinal direction are semicircular, or a long-hole shape. Incidentally, the long-hole shape is an oval shape or a shape similar to an oval shape (for example, an egg shape, an elliptical shape, and the like). It is a matter of course that each of the filter chamber 30 and the filter F may have a square shape, a rectangular shape, a parallelogram shape, a polygonal shape, or a fan shape. However, in the case of a shape having corners, air bubbles are likely to stay at the corners. Therefore, it is preferable that each of the filter chamber 30 and the filter F has a shape as described above without corners so that air bubbles are not likely to stay. In addition, in the present embodiment, since the volume of the first recess portion 11 is larger than the volume of the second recess portion 21, the volume of the upstream chamber 31 is larger than the volume of the downstream chamber 32. Since the upstream chamber 31 has a relatively large volume in this manner, a large number of air bubbles can be caused to stay in the upstream chamber 31. Incidentally, when the volume of the upstream chamber 31 is small, air bubbles block the filter F, the effective area of the filter F is reduced, a flow path resistance is increased, supply of ink to the liquid ejecting head H becomes poor, cleaning for discharge of the air bubbles needs to be performed frequently, and the amount of ink wastefully consumed is increased. When the upstream chamber 31 has a relatively large volume as in the present embodiment, a large number of air bubbles can be caused to stay in the upstream chamber 31, poor ink supply can be suppressed, and wasteful consumption of ink can be suppressed.

In addition, the filter unit 2 includes an inflow path 33 that communicates with the upstream chamber 31 of the filter chamber 30, a first outflow path 34 that communicates with the downstream chamber 32 of the filter chamber 30, and a second outflow path 35 that communicates with the first outflow path 34.

A first flow path coupling portion 12 that protrudes in a-Y direction and that has a tubular shape is provided at a surface of the first flow path member 10 that faces the −Y direction. The inflow path 33 extends along the Y-axis direction such that one end thereof is open at a tip end surface of the first flow path coupling portion 12 and another end thereof is open at an inner wall surface of the upstream chamber 31 that is on a-Y direction side. In the present embodiment, an opening of the inflow path 33 that is at the tip end surface of the first flow path coupling portion 12 will be referred to as an inlet 33a. Ink from the outside of the filter unit 2 is introduced through the inlet 33a.

A second flow path coupling portion 22 that protrudes in the +Z direction and that has a tubular shape is provided at a surface of the second flow path member 20 that faces the +Z direction. The first outflow path 34 extends along the Z-axis direction such that one end thereof is open at a tip end surface of the second flow path coupling portion 22 and another end thereof is open at a bottom surface of the downstream chamber 32 in the +Z direction. An outflow port 34a is provided at a boundary between the first outflow path 34 and the downstream chamber 32. That is, the outflow port 34a through which ink flows out from the downstream chamber 32 is open in the +Z direction.

In addition, a third flow path coupling portion 23 that protrudes in the +Z direction and that has a tubular shape is provided at the surface of the second flow path member 20 that faces the +Z direction. In addition, a fourth flow path coupling portion 24 that protrudes in a +Y direction and that has a tubular shape is provided at a surface of the first flow path member 10 that faces the +Y direction. The second outflow path 35 includes a first portion 36 that is provided along the Z-axis direction over the first flow path member 10 and the second flow path member 20 and a second portion 37 that is provided at the second flow path member 20 and that is provided along the Y-axis direction. One end of the first portion 36 that is on a side opposite to another end of the first portion 36 that communicates with the second portion 37 is open at a tip end surface of the third flow path coupling portion 23 and an end portion of the second portion 37 that is on a side opposite to one end of the second portion 37 that communicates with the first portion 36 is open at a tip end surface of the fourth flow path coupling portion 24. An opening of the second outflow path 35 that is at the tip end surface of the fourth flow path coupling portion 24 will be referred to as an outlet 35a. Ink in the filter chamber 30 is caused to flow out through the outlet 35a, via the downstream chamber 32.

In addition, the second flow path coupling portion 22 and the third flow path coupling portion 23 are coupled to each other via a communication pipe 40 in which a communication path 41 is provided and that has a tubular shape. That is, the first outflow path 34 and the second outflow path 35 are coupled to each other via the communication path 41. In the case of such a filter unit 2, ink from the liquid storage portion 3 is supplied to the inflow path 33 through the inlet 33a. The ink in the inflow path 33 is supplied to the upstream chamber 31, and the ink in the upstream chamber 31 is supplied to the downstream chamber 32 via the filter F. The ink in the downstream chamber 32 is supplied to the liquid ejecting head H through the outlet 35a via the first outflow path 34, the communication path 41, and the second outflow path 35.

Here, as described above, the inlet 33a is open in a direction perpendicular to a virtual plane extending along the filter F (that is, the XY plane defined by the X axis and the Y axis), that is, a direction intersecting the Z-axis direction (in the present embodiment, the −Y direction). In addition, the outlet 35a is open in the +Y direction, which is a direction opposite to the −Y direction. The inlet 33a is disposed at a position at which the inlet 33a overlaps with the outlet 35a as seen in the +Y direction. In the present embodiment, a virtual center line that passes through a center of the inlet 33a and that extends in the +Y direction passes through a center of the outlet 35a. That is, the center of the inlet 33a and the center of the outlet 35a are disposed at positions at which the centers overlap with each other as seen in the +Y direction. Note that although the +Y direction has been used as an example of the direction perpendicular to the virtual plane extending along the filter F in the present embodiment, the present disclosure is not particularly limited thereto. When a direction intersecting the virtual plane extending along the filter F is referred to as a first direction and a direction intersecting the first direction is referred to as a second direction, the smaller angle of angles formed by a first straight line extending in the first direction and a second straight line extending in the second direction is preferably an angle of 45 degrees or more, more preferably an angle of 60 degrees or more, and still more preferably an angle of 75 degrees or more as seen along a line of intersection between the two straight lines. In the present embodiment, the above-described angle is an angle of 90 degrees since the +Z direction is an example of the “first direction”, and the +Y direction is an example of the “second direction”.

Since the inlet 33a and the outlet 35a are disposed at positions at which the inlet 33a and the outlet 35a overlap with each other as seen in the +Y direction as described above, the filter unit 2 can be rotated around a rotation axis C extending along a line that links a portion at which the inlet 33a is provided and a portion at which the outlet 35a is provided to each other. In addition, in the present embodiment, the center of the inlet 33a and the center of the outlet 35a are disposed at positions at which the centers overlap with each other as seen in the +Y direction and thus the filter unit 2 is easily rotated around the rotation axis C extending along a line that links the center of the inlet 33a and the center of the outlet 35a. It is a matter of course that the filter unit 2 is rotatable even when the inlet 33a and the outlet 35a are positioned to overlap with each other in a state where the centers of the inlet 33a and the outlet 35a do not coincide with each other as seen in the +Y direction.

In addition, in the present embodiment, the inlet 33a is disposed at a position at which the inlet 33a overlaps with the filter chamber 30 as seen in the +Y direction. Since the inlet 33a is disposed at the position at which the inlet 33a overlaps with the filter chamber 30 as seen in the +Y direction in this manner, the size of the filter unit 2 can be reduced in the Z-axis direction and the size of a space for rotation of the filter unit 2 can be reduced in comparison with a case where the inlet 33a is disposed at a position at which the inlet 33a does not overlap with the filter chamber 30 as seen in the +Y direction. Similarly, the outlet 35a is disposed at a position at which the outlet 35a overlaps with the filter chamber 30 as seen in the +Y direction. This also results in reduction in size of the filter unit 2 in the Z-axis direction and reduction in size of a space for rotation of the filter unit 2.

Furthermore, the inlet 33a is disposed at a position at which the inlet 33a overlaps with the upstream chamber 31 as seen in the +Y direction. Since the inlet 33a is disposed at the position at which the inlet 33a overlaps with the upstream chamber 31 of which the volume is larger than the volume of the downstream chamber 32, the upstream chamber 31 and the inlet 33a can be formed in the same member (in the present embodiment, the first flow path member 10). Therefore, ink leakage can be suppressed in comparison with a case where an inlet is formed by two members. Similarly, the outlet 35a is disposed at a position at which the outlet 35a overlaps with the upstream chamber 31 as seen in the +Y direction. This also results in suppression of ink leakage.

Here, the first flow path coupling portion 12 of the filter unit 2 is coupled to the supply tube T1 via a first coupling pipe 50 having a tubular shape and a rotary coupling 60. In addition, the fourth flow path coupling portion 24 of the filter unit 2 is coupled to the supply tube T2 via a second coupling pipe 51 having a tubular shape and a rotary coupling 60.

Each of the rotary couplings 60 is a coupling that is also called a rotary joint or a swivel joint and is a coupling that rotatably couples two pipes. Since the filter unit 2 is coupled to the supply tubes T1 and T2 via such rotary couplings 60, the filter unit 2 is rotatable around the rotation axis C extending along an axis (in the present embodiment, the Y axis) that links the first flow path coupling portion 12 provided with the inlet 33a and the fourth flow path coupling portion 24 provided with the outlet 35a.

Incidentally, each rotary coupling 60 includes a first main body 62 in which a first flow path 61 is provided to penetrate along the Y-axis direction, and a second main body 64 in which a second flow path 63 is provided to penetrate along the Y-axis direction. One end portion of a sliding bearing portion 65 is fixed to the second flow path 63 of the second main body 64. In addition, another end portion of the sliding bearing portion 65 is fixed in the first flow path 61 of the first main body 62 via a ball bearing 66. A first seal member 67 is provided between the sliding bearing portion 65 outside the ball bearing 66 and an inner wall of the first main body 62, and the first seal member 67 restrains liquid in the first flow path 61 from entering a ball bearing 66 side. In addition, a second seal member 68 such as an O-ring is provided between the sliding bearing portion 65 and an inner wall of the second main body 64, and the second seal member 68 restrains liquid in the second flow path 63 from leaking to the outside of the second flow path 63.

In such a rotary coupling 60, the first main body 62 and the second main body 64 relatively rotate with respect to each other via the sliding bearing portion 65. A rotation axis of the rotary coupling 60 is a direction along a direction in which the first flow path 61 and the second flow path 63 extend, that is, a direction along the Y-axis direction. In addition, the rotation axis C is disposed at a position at which the rotation axis C passes through centers of the first flow path 61 and the second flow path 63 as seen in the Y-axis direction.

In addition, regarding the rotary couplings 60, since the filter unit 2 is coupled to the supply tubes T1 and T2 via such rotary couplings 60, the filter unit 2 is rotatable around the rotation axis C with respect to the supply tubes T1 and T2. Note that the supply tube T1 may be directly coupled to the first flow path coupling portion 12 with no rotary coupling 60 interposed therebetween and the supply tube T2 may be directly coupled to the fourth flow path coupling portion 24 with no rotary coupling 60 interposed therebetween.

As shown in FIG. 2, a rotation mechanism 70 that rotates the filter unit 2 around the rotation axis C includes a pair of bearings 71 that supports the filter unit 2 to be rotatable around the rotation axis C, a gear 72 that is provided at an end portion of the filter unit 2 in the −Y direction and that has a cylindrical shape, and an electric motor 73.

A pinion gear 73a provided at a rotation shaft of the electric motor 73 is disposed to mesh with the gear 72 provided at the filter unit 2, and the filter unit 2 rotates around the rotation axis C as the pinion gear 73a rotates the gear 72 due to a driving force of the electric motor 73. It is a matter of course that the rotation mechanism 70 may include another gear that transmits the driving force of the electric motor 73. In addition, the rotation mechanism 70 may not be driven by the electric motor 73, and for example, a combination of the power of an electromagnet, an oil pressure, or an air pressure and a gear transmitting the power may also be used.

With such a rotation mechanism 70, the filter unit 2 can be rotated to switch between the first posture at the time of printing which is shown in FIG. 3 and the second posture at the time of maintenance which is shown in FIG. 4.

Rotation of the filter unit 2 that is performed by the rotation mechanism 70 and printing performed by the liquid ejecting head H are controlled by the control device 4.

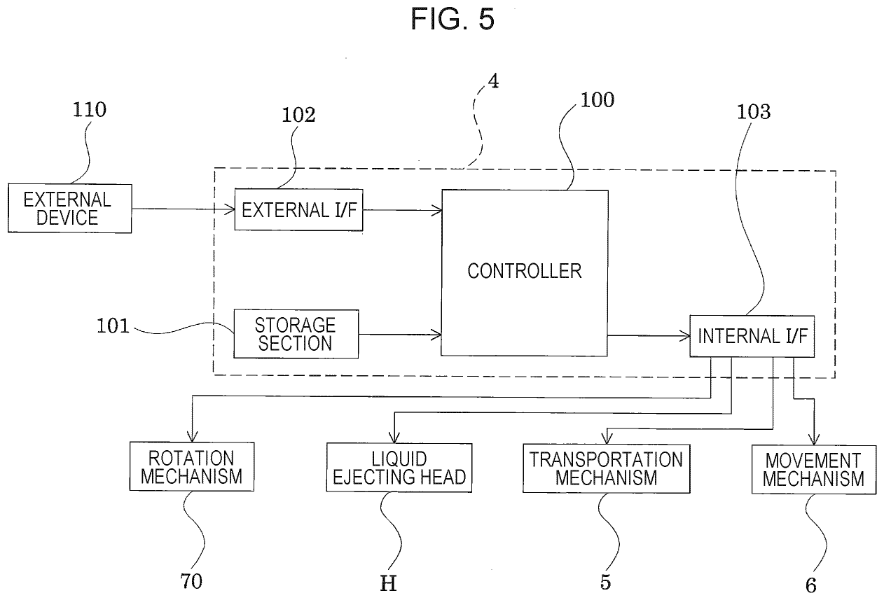

FIG. 5 is a functional block diagram of the liquid ejecting apparatus 1. The control device 4 is an element that controls the entire liquid ejecting apparatus 1, and includes a controller 100, a storage section 101, an external I/F (interface) 102, and an internal I/F 103. Printing data indicating an image to be printed on the medium S is transmitted from an external device 110 (for example, a host computer) to the external I/F 102, and the liquid ejecting head H, the movement mechanism 6, and the transportation mechanism 5 are coupled to the internal I/F 103. The liquid ejecting head H, the movement mechanism 6, and the transportation mechanism 5 are elements recording an image on the medium S under the control of the control device 4. In addition, the controller 100 is coupled to the rotation mechanism 70 via the internal I/F 103.

The storage section 101 includes a ROM that stores a control program and the like and a RAM that temporarily stores various data necessary for image printing (ejection of ink droplets from each of the nozzles N). The controller 100 executes the control program stored in the storage section 101 to comprehensively control each element of the liquid ejecting apparatus 1, for example, a transportation motor of the transportation mechanism 5 or a transportation motor of the movement mechanism 6. The controller 100 converts printing data into ejection data for an instruction to eject or not to eject ink droplets from each of the nozzles N of the liquid ejecting head H and transmits the ejection data to the liquid ejecting head H, the printing data being transmitted from the external device 110 to the external I/F 102.

Furthermore, at the time of printing, the control device 4 controls the rotation mechanism 70 such that the filter unit 2 rotates around the rotation axis C and moves to the first posture shown in FIG. 3. The first posture is a posture in which the lower surface Fb of the filter F faces the gravity direction, that is, the +Z direction. With the filter unit 2 being in the first posture, the liquid ejecting head H performs a printing operation of ejecting ink to the medium S. That is, the first posture may be referred to as a printing posture.

In addition, at the time of maintenance, the control device 4 controls the rotation mechanism 70 such that the filter unit 2 rotates around the rotation axis C and moves the second posture shown in FIG. 4. The second posture is a posture in which the lower surface Fb of the filter F faces the direction opposite to the gravity direction, that is, the −Z direction. With the filter unit 2 being in the second posture, maintenance in which ink is discharged to the outside from the plurality of nozzles N via the filter chamber 30 is performed. That is, the second posture may be referred to as a maintenance posture.

Here, in the case of the first posture shown in FIG. 3, air bubbles 200 that are captured by the filter F and that are contained in ink move to a ceiling of the upstream chamber 31, that is, toward a wall surface on the −Z direction side, due to buoyancy. In the case of the first posture, the air bubbles cannot be favorably discharged even when maintenance of the liquid ejecting head H is performed. Here, examples of the maintenance of the liquid ejecting head H include cleaning such as suction cleaning in which the pressure in a closed space in a cap (not shown), which has a recess-like shape and in which the nozzles N of the liquid ejecting head H are open, is made negative by means of a negative pressure generation mechanism (not shown) via a tube (not shown) coupled to the inside of the cap in a state where the cap abuts a nozzle surface of the liquid ejecting head H so that ink is sucked from the nozzles N of the liquid ejecting head H together with the air bubbles 200 and pressurization cleaning in which ink is pressurized by a pressurization mechanism such as the pump 7 at a position upstream of the upstream chamber 31 so that the air bubbles 200 in the filter chamber 30 are discharged from the nozzles N. As the pressurization mechanism, any mechanism such as a tube pump, a diaphragm pump, and a piston pump can be adopted. In addition, examples of the maintenance of the liquid ejecting head H include so-called initial filling in which the liquid ejecting head H is filled with ink for the first time. That is, the maintenance of the liquid ejecting head H is to apply, in a direction from the upstream chamber 31 to the downstream chamber 32, a pressure higher than a pressure at the time of printing. Even when the maintenance is performed with the filter unit 2 being in the first posture, the air bubbles 200 cannot be pressed against the filter F, the air bubbles 200 cannot pass through the filter F, and the air bubbles 200 cannot be easily discharged from the filter chamber 30.

Therefore, at the time of the maintenance of the liquid ejecting head H, the filter unit 2 is rotated around the rotation axis C such that the posture of the filter unit 2 changes from the first posture shown in FIG. 3 to the second posture shown in FIG. 4. That is, the filter unit 2 is rotated such that the lower surface Fb of the filter F becomes a surface that faces a direction opposite to the +Z direction which is the gravity direction, that is, the −Z direction. In this manner, the maintenance such as cleaning and initial filling is performed in a state where the filter unit 2 is in the second posture. In the case of the second posture, the air bubbles 200 in the upstream chamber 31 move in the −Z direction due to buoyancy and the air bubbles 200 are disposed at positions at which the air bubbles 200 come into contact with the filter F. Therefore, when the maintenance is performed with the filter unit 2 being in the second posture, it is possible to apply a pressure in a direction from the upstream chamber 31 to the downstream chamber 32 in a state where the air bubbles 200 are pressed against the filter F. Therefore, the air bubbles 200 easily pass through the filter F and the air bubbles 200 are easily discharged from the filter chamber 30 when the maintenance is performed with the filter unit 2 being in the second posture. As described above, the air bubbles 200 in the filter chamber 30 can be easily discharged through the maintenance. Therefore, the air bubbles 200 remaining in the filter chamber 30 at the time of printing can be restrained from flowing into the liquid ejecting head H at an unexpected time and occurrence of discharge failure of ink droplets from the liquid ejecting head H can be suppressed. Note that in the present embodiment, the outflow port 34a is open in the +Z direction of the downstream chamber 32 in the case of the first posture shown in FIG. 3. Therefore, in the case of the second posture shown in FIG. 4, air bubbles in the downstream chamber 32 are easily discharged from the outflow port 34a due to the buoyancy of the air bubbles since the outflow port 34a is open in the −Z direction of the downstream chamber 32.

In addition, since printing is performed with the filter unit 2 being in the first posture shown in FIG. 3, the air bubbles 200 stay at a surface of the upstream chamber 31 in the −Z direction due to buoyancy, the air bubbles 200 do not block the filter F, and a decrease in effective area of the filter F can be suppressed. Therefore, it is possible to suppress an increase in flow path resistance of the filter F that is caused when the air bubbles 200 block the filter F, and it is possible to suppress poor ink supply to the liquid ejecting head H. In addition, when the air bubbles 200 come into contact with the filter F, a cleaning operation needs to be performed frequently for discharge of the air bubbles 200, which results in an increase in amount of ink wastefully consumed. Since printing is performed with the filter unit 2 being in the first posture, the cleaning operation does not need to be performed frequently and wasteful consumption of ink can be suppressed.

Incidentally, when printing is performed with the filter unit 2 being in the second posture, the air bubbles 200 come into contact with the filter F and the air bubbles 200 block the filter F, which results in poor ink supply or an increase in amount of ink wastefully consumed for frequent cleaning. As described above, in the present embodiment, printing is performed with the filter unit 2 being in the first posture so that poor ink supply is suppressed and wasteful consumption of ink is suppressed, and maintenance is performed with the filter unit 2 being in the second posture so that the air bubble discharge performance can be improved.

Note that in the present embodiment, the +Z direction is an example of the “gravity direction”, the +Z direction is an example of a “first direction”, the −Y direction is an example of a “second direction”, and the +Y direction is an example of a “third direction”.

Note that in the present embodiment, the second direction is a direction orthogonal to the first direction. However, the present disclosure is not particularly limited thereto and the second direction may be a direction intersecting the first direction. That is, the second direction may be a direction inclined by less than 90 degrees with respect to the −Y direction orthogonal to the +Z direction, the +Z direction being the first direction. It is a matter of course that the second direction is not limited to the −Y direction or a direction inclined with respect to the −Y direction and may be any direction along the X-axis direction or a direction inclined with respect to such a direction.

In addition, in the present embodiment, the posture in which the lower surface Fb of the filter F faces the +Z direction has been described as the first posture. However, the present disclosure is not particularly limited thereto. The expression “the lower surface Fb of the filter F faces the gravity direction” also means a state where a normal vector of the lower surface Fb of the filter F has a component of the gravity direction. That is, a normal direction of the lower surface Fb may be a direction inclined by less than 90 degrees with respect to the +Z direction. Similarly, although the posture in which the lower surface Fb of the filter F faces the −Z direction has been described as the second posture, the present disclosure is not particularly limited thereto. The expression “the lower surface Fb of the filter F faces a direction opposite to the gravity direction” also means a state where a normal vector of the lower surface Fb of the filter F has a component of the direction opposite to the gravity direction. That is, a normal direction of the lower surface Fb may be a direction inclined by less than 90 degrees with respect to the −Z direction. Even in the case of such a second posture, the air bubbles 200 are moved toward the upper surface Fa of the filter F due to buoyancy and the air bubbles 200 easily pass through the filter F and are easily discharged to the outside at the time of initial filling and cleaning.

### Embodiment 2

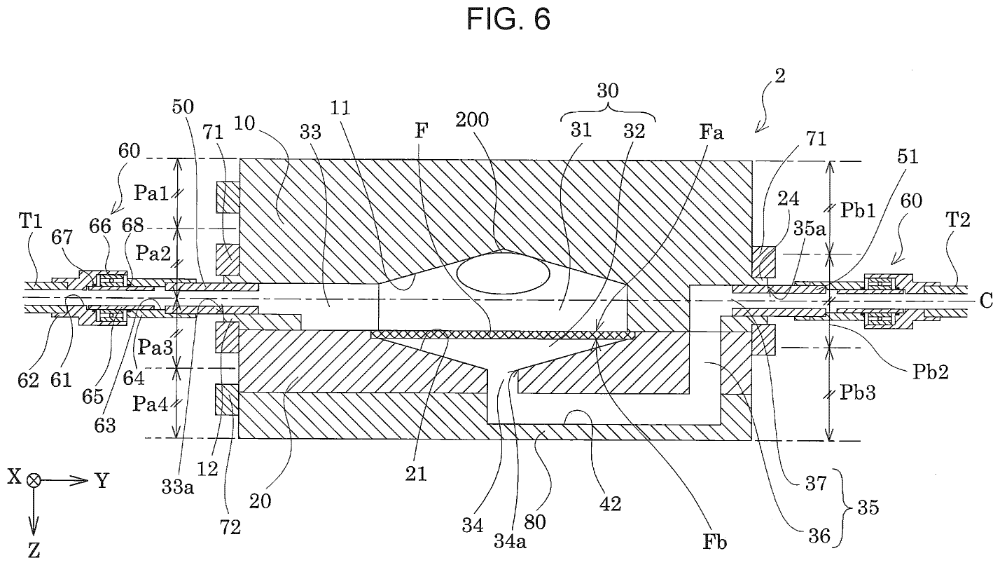

FIG. 6 is a cross-sectional view showing the posture of the filter unit 2 according to Embodiment 2 of the present disclosure at the time of printing. Note that the same reference numerals are used for the same members as those in the above-described embodiment, and repetitive description will be omitted.

As shown in FIG. 6, the filter unit 2 includes the first flow path member 10, the second flow path member 20, and a third flow path member 80.

The third flow path member 80 is stacked on a surface of the second flow path member 20 that faces the +Z direction. A communication path 42 is provided at a stacking interface between the second flow path member 20 and the third flow path member 80.

That is, in the present embodiment, the third flow path member 80 is provided instead of the communication pipe 40 of Embodiment 1 described above.

The communication path 42 is formed by providing a recess portion that is open at a surface of the third flow path member 80 that faces the −Z direction and covering an opening of the recess portion with the second flow path member 20. It is a matter of course that the communication path 42 may be formed by providing a recess portion at the second flow path member 20 and covering the recess portion with the third flow path member 80 or may be formed by providing recess portions at both the second flow path member 20 and the third flow path member 80. In addition, the communication path 42 may not be provided at the stacking interface between the second flow path member 20 and the third flow path member 80 and may be provided at an intermediate portion of the third flow path member 80 in the Z-axis direction. However, when the communication path 42 is provided at the stacking interface between the second flow path member 20 and the third flow path member 80, the number of components is reduced and thus the communication path 42 can be easily formed.

In the case of such a filter unit 2, the inlet 33a is disposed at a central portion of the filter unit 2 in a direction orthogonal to the +Y direction (in the present embodiment, the +Z direction). Here, as shown in FIG. 6, when regions obtained by evenly dividing the filter unit 2 into four parts in the +Z direction are referred to as regions Pa1 to Pa4 in an order along the +Z direction, the central portion of the filter unit 2 refers to two central regions Pa2 and Pa3 of the four regions Pa1 to Pa4 obtained through division. In addition, when regions obtained by dividing the filter unit 2 into three parts in the +Z direction are referred to as regions Pb1 to Pb3 in an order along the +Z direction, the central portion of the filter unit 2 preferably refers to one central region Pb2 of the three regions Pb1 to Pb3 obtained through division. The outlet 35a is also disposed at the central portion of the filter unit 2 in the +Z direction. The central portion that defines the position of the outlet 35a described herein is the same as the central portion of the inlet 33a.

As described above, since the inlet 33a and the outlet 35a are disposed at the central portion of the filter unit 2 in the +Z direction, the size of a space for rotation of the filter unit 2 between the first posture and the second posture can be reduced. Therefore, it is possible to reduce the size of a wasteful space for rotation of the filter unit 2 and to reduce the size of the liquid ejecting apparatus 1.

Note that in the present embodiment, the +Z direction is an example of the “gravity direction”, the +Z direction is an example of a “first direction”, the −Y direction is an example of a “second direction”, and the +Y direction is an example of a “third direction”.

Note that in the present embodiment, the second direction is a direction orthogonal to the first direction. However, the present disclosure is not particularly limited thereto and the second direction may be a direction intersecting the first direction. That is, the second direction may be a direction inclined by less than 90 degrees with respect to the −Y direction orthogonal to the +Z direction, the +Z direction being the first direction. It is a matter of course that the second direction is not limited to the −Y direction or a direction inclined with respect to the −Y direction and may be any direction along the X-axis direction or a direction inclined with respect to such a direction.

Note that in the present embodiment, the posture in which the lower surface Fb of the filter F faces the +Z direction has been described as the first posture. However, the present disclosure is not particularly limited thereto. The expression “the lower surface Fb of the filter F faces the gravity direction” also means a state where a normal vector of the lower surface Fb of the filter F has a component of the gravity direction. That is, a normal direction of the lower surface Fb may be a direction inclined by less than 90 degrees with respect to the +Z direction. Similarly, although the posture in which the lower surface Fb of the filter F faces the −Z direction has been described as the second posture, the present disclosure is not particularly limited thereto. The expression “the lower surface Fb of the filter F faces a direction opposite to the gravity direction” also means a state where a normal vector of the lower surface Fb of the filter F has a component of the direction opposite to the gravity direction. That is, a normal direction of the lower surface Fb may be a direction inclined by less than 90 degrees with respect to the −Z direction. Even in the case of such a second posture, the air bubbles 200 are moved toward the upper surface Fa of the filter F due to buoyancy and the air bubbles 200 easily pass through the filter F and are easily discharged to the outside at the time of initial filling and cleaning.

### Embodiment 3

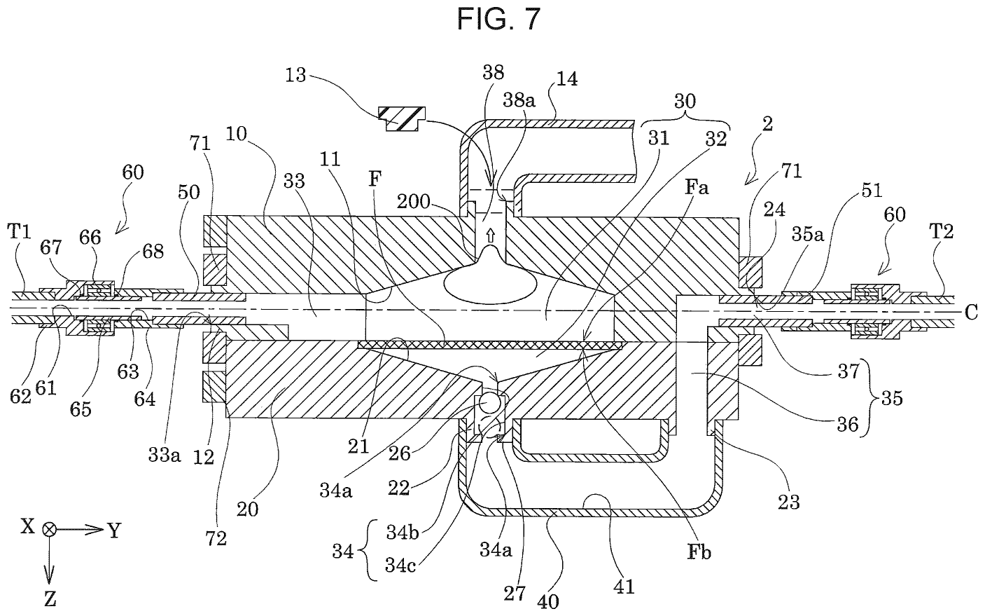

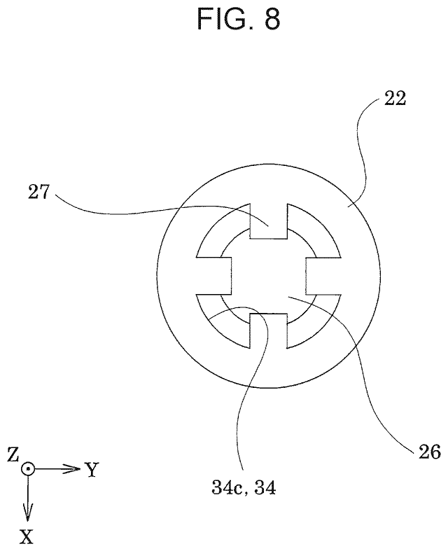

FIG. 7 is a cross-sectional view of the filter unit 2 according to Embodiment 3 of the present disclosure. FIG. 8 is a view showing the second flow path coupling portion 22 of the filter unit 2 according to Embodiment 3 as seen in plan view along the −Z direction.

Note that the same reference numerals are used for the same members as those in the above-described embodiment, and repetitive description will be omitted.

As shown in FIG. 7, the filter unit 2 of the present embodiment includes the first flow path member 10 and the second flow path member 20. The filter unit 2 includes the filter chamber 30 in which the filter F is provided, and the upstream chamber 31 and the downstream chamber 32 of the filter chamber 30 are defined by the filter F.

As with the above-described embodiments, the filter unit 2 is provided with the inflow path 33 that communicates with the upstream chamber 31 and the first outflow path 34 and the second outflow path 35 that communicate with the downstream chamber 32.

In addition, the filter unit 2 is provided with a discharge path 38 through which the upstream chamber 31 communicates with the outside. One end of the discharge path 38 is open at an inner wall surface of the upstream chamber 31 that is on the −Z direction side, and another end is open at a surface of the first flow path member 10 that faces the −Z direction. In the present embodiment, the other end of the discharge path 38 will be referred to as a discharge port 38a.

A waste liquid tube 14 is coupled to the discharge port 38a. The waste liquid tube 14 is coupled to a waste liquid tank (not shown), and liquid discharged from the discharge port 38a is discharged to the waste liquid tank via a flow path in the waste liquid tube 14 at the time of cleaning in which air bubbles in the upstream chamber 31 are discharged.

Note that it is preferable that a valve mechanism (not shown) that can open and close a waste liquid flow path between the upstream chamber 31 and the waste liquid tank is provided in the waste liquid flow path so that ink is prevented from flowing from the upstream chamber 31 toward the waste liquid tank at the time of printing. As the valve mechanism, an electromagnetic valve or a diaphragm valve that can be opened and closed by being controlled by the control device 4 can be adopted. In addition, the valve mechanism may be a differential pressure regulating valve that closes the waste liquid flow path at the time of printing and that opens the waste liquid flow path at the time of maintenance with a pressure at a position downstream of (a waste liquid tank side) a valve body being lower than a predetermined pressure. In addition, the valve mechanism may be provided as a part of the filter unit 2, or may be provided separately from the filter unit 2.

In addition, the first outflow path 34 includes a check valve. Specifically, the first outflow path 34 includes a small-diameter portion 34b that communicates with the downstream chamber 32 and a large-diameter portion 34c that is provided downstream of the small-diameter portion 34b and has an inner diameter larger than the inner diameter of the small-diameter portion 34b. In addition, a ball 26 made of a spherical elastic member is provided in the large-diameter portion 34c. The outer diameter of the ball 26 is larger than the inner diameter of the small-diameter portion 34b and is smaller than the inner diameter of the large-diameter portion 34c. When so-called backflow in which ink flows in a backward direction from the first outflow path 34 toward the downstream chamber 32 occurs, the ball 26 blocks the first outflow path 34 by abutting a step between the large-diameter portion 34c and the small-diameter portion 34b due to the flow of the ink. In addition, when ink flows in a forward direction from the downstream chamber 32 toward the first outflow path 34, the ball 26 moves in the +Z direction due to the flow of the ink, a gap is formed between the ball 26 and the step, and the ink flows through a space between the large-diameter portion 34c and the ball 26. That is, the ball 26 functions as a check valve that allows ink to flow toward the outlet 35a from the downstream chamber 32 and that prevents the ink from flowing toward the downstream chamber 32 from the outlet 35a. Note that as shown in FIG. 8, an opening edge portion of the second flow path coupling portion 22 is provided with four protrusions 27 protruding inward. With the protrusions 27, the ball 26 can be restrained from moving toward the communication path 41 side downstream of the first outflow path 34 due to the weight of the ball 26 and the flow of ink.

In the case of such a filter unit 2, at the time of printing, it is possible to cause ink to flow toward the outlet 35a from the inlet 33a via the filter chamber 30 by closing the waste liquid flow path with the above-described valve mechanism. At this time, the ball 26 does not hinder the ink from flowing in the forward direction.

In addition, at the time of maintenance, it is possible to discharge ink in the upstream chamber 31 to the waste liquid tank outside the filter unit 2 together with the air bubbles 200 staying at the upstream chamber 31 by performing cleaning in which liquid in the upstream chamber 31 is sucked from a waste liquid tube 14 side by means of the negative pressure generation mechanism (not shown) or cleaning in which liquid from a position upstream of the upstream chamber 31 is pressurized by the pump 7 or the like. At this time, since the discharge path 38 is open at the inner wall surface of the upstream chamber 31 that is on the −Z direction side, the air bubbles 200 stay near the discharge path 38 due to buoyancy. Therefore, the air bubbles 200 are easily discharged from the discharge path 38 at the time of maintenance. Note that when the valve mechanism is an electromagnetic valve or a diaphragm valve, the control device 4 controls the valve mechanism such that the waste liquid flow path is opened at the time of maintenance and the waste liquid flow path is closed at the time of printing. In addition, when the valve mechanism is a differential pressure regulating valve, a valve is opened as a pressure at a position downstream of a valve body is made negative at the time of cleaning and the waste liquid flow path is closed when the cleaning is not to be performed, in the case of the cleaning in which liquid in the upstream chamber 31 is sucked from the waste liquid tube 14 side by means of the negative pressure generation mechanism (not shown).

Therefore, control for an operation of opening and closing the valve mechanism can be made unnecessary. In addition, when the valve mechanism is a differential pressure regulating valve and a mechanism that causes an external force moving a valve body of the differential pressure regulating valve to act in response to a control signal from the control device 4 is provided, as with an electromagnetic valve or a diaphragm valve, the waste liquid flow path can also be opened at the time of the cleaning in which liquid from a position upstream of the upstream chamber 31 is pressurized by the pump 7 or the like. Note that it is preferable that the cleaning in which liquid in the upstream chamber 31 is sucked from the waste liquid tube 14 side by means of the negative pressure generation mechanism (not shown) is performed at the time of maintenance so that the check valve functions at the time of cleaning.

Note that, when the discharge port 38a is blocked by a cap 13 that is provided to be attachable and detachable with respect to the discharge port 38a and that is formed of an elastic material such as an elastomer, the filter unit 2 of the present embodiment can be used in the same manner as in Embodiment 1 described above, that is, the filter unit 2 can be used in a state of being in the first posture in which the lower surface Fb of the filter F faces the +Z direction at the time of printing and can be used in a state of being in the second posture in which the lower surface Fb of the filter F faces the −Z direction at the time of maintenance. In addition, when the cap 13 of the discharge port 38a is removed, the waste liquid tube 14 is coupled to the discharge port 38a, and a valve (the valve mechanism described above) that can open and close a flow path is provided at an intermediate portion of the waste liquid tube 14, it is possible to perform both printing and maintenance in a state where the waste liquid tube 14 is coupled to the discharge port 38a only by opening and closing the valve provided in the waste liquid tube 14 without replacing the waste liquid tube 14 and the cap 13 with each other at the time of printing.

### Embodiment 4

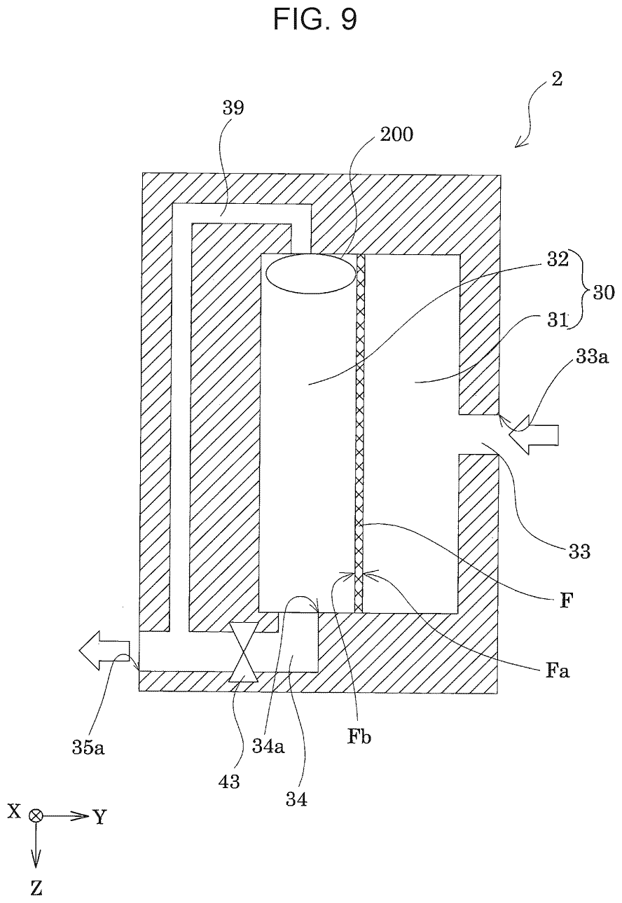

FIG. 9 is a cross-sectional view of the filter unit 2 according to Embodiment 4 of the present disclosure. Note that the same reference numerals are used for the same members as those in the above-described embodiment, and repetitive description will be omitted.

As shown in FIG. 9, the filter unit 2 of the present embodiment includes the filter chamber 30 in which the filter F is provided. The filter unit 2 is disposed such that the lower surface Fb of the filter F faces the −Y direction. The upstream chamber 31 and the downstream chamber 32 of the filter chamber 30 are defined by the filter F.

In addition, the filter unit 2 includes the inflow path 33, the first outflow path 34, and a bypass flow path 39.

One end of the inflow path 33 communicates with an inner wall surface of the upstream chamber 31 in the +Y direction, and another end of the inflow path 33 is open at a surface of the filter unit 2 that faces the +Y direction. An opening of the other end will be referred to as the inlet 33a. The supply tube T1 is coupled to the inlet 33a so that ink from the liquid storage portion 3 is supplied.

One end of the first outflow path 34 communicates with an inner wall surface of the downstream chamber in the +Z direction, and another end of the first outflow path 34 is open at a surface of the filter unit 2 that faces the −Y direction. An opening of the other end will be referred to as the outlet 35a. The supply tube T2 is coupled to the outlet 35a and ink from the outlet 35a is supplied to the liquid ejecting head H. In addition, a valve 43 that opens and closes the first outflow path 34 is provided at an intermediate portion of the first outflow path 34. As the valve 43, for example, an electromagnetic valve, a manual valve, or the like is used.

One end of the bypass flow path 39 communicates with an inner wall surface of the downstream chamber 32 in the −Z direction, and another end of the bypass flow path 39 communicates with a portion of the first outflow path 34 that is downstream of the valve 43. The flow path resistance of the bypass flow path 39 is larger than the flow path resistance of the first outflow path 34. That is, the bypass flow path 39 has a smaller cross-sectional area than the first outflow path 34 in a direction across the flow of ink and is a long path. Therefore, in a state where the valve 43 is open, ink in the downstream chamber 32 flows out to the outside from the outlet 35a via the first outflow path 34. At this time, the ink is less likely to flow in the bypass flow path 39 and the air bubbles 200 staying in the −Z direction in the downstream chamber 32 due to buoyancy are less likely to be discharged downstream from the bypass flow path 39. On the other hand, in a state where the valve 43 is closed, the ink in the downstream chamber 32 flows out to the outside from the outlet 35a via the bypass flow path 39. Therefore, the air bubbles 200 staying in the −Z direction in the downstream chamber 32 due to buoyancy can be discharged to the outside from the outlet 35a via the bypass flow path 39. That is, at the time of printing, the valve 43 is opened so that the air bubbles 200 in the downstream chamber 32 are not sent to the liquid ejecting head H, and at the time of maintenance, the valve 43 is closed so that the air bubbles 200 in the downstream chamber 32 are sent to the liquid ejecting head H and the air bubbles 200 can be discharged to the outside from the nozzles N or the like of the liquid ejecting head H. It is a matter of course that even at the time of initial filling in which the liquid ejecting head H is filled with ink for the first time, the air bubbles 200 in the filter chamber 30 can be discharged from the outlet 35a via the bypass flow path 39 when the valve 43 is closed, which results in improvement in air bubble discharge performance.

Note that in the present embodiment, the +Z direction is an example of a “gravity direction”, the +Z direction is an example of a “first direction”, the +Y direction is an example of a “second direction”, and the −Y direction is an example of a “third direction”.

In addition, in the present embodiment, the second direction is a direction orthogonal to the first direction. However, the present disclosure is not particularly limited thereto and the second direction may be a direction intersecting the first direction. That is, the second direction may be a direction inclined by less than 90 degrees with respect to the +Y direction orthogonal to the +Z direction, the +Z direction being the first direction. It is a matter of course that the second direction is not limited to the +Y direction or a direction inclined with respect to the +Y direction and may be any direction along the X-axis direction or a direction inclined with respect to such a direction.

### Other Embodiments

Although each embodiment of the present disclosure has been described above, the basic configuration of the present disclosure is not limited to the above embodiments.

For example, in each of the above-described embodiments, a configuration in which the filter chamber 30 is provided in the filter unit 2 has been described. However, the present disclosure is not particularly limited thereto. For example, a filter chamber may be provided in the liquid ejecting head H. The air bubble discharge performance can be improved with the liquid ejecting head H moving between a first posture and a second posture.

In addition, in each of the above-described embodiments, the first flow path coupling portion 12 and the fourth flow path coupling portion 24, each of which has a tubular shape, have been described as an example. However, the present disclosure is not particularly limited thereto and any one or both of the first flow path coupling portion 12 and the fourth flow path coupling portion 24 may have a needle-like shape with a sharp tip.

In each of the above-described embodiments, the liquid ejecting head H is disposed to eject ink in the +Z direction. However, the present disclosure is not limited thereto and a direction in which the liquid ejecting head H ejects ink is not limited to the +Z direction as long as the filter unit is in a posture as in each of the above-described embodiments.

### Supplementary Notes

From the embodiments described above, for example, the following configurations can be understood.

According to Aspect 1, which is a preferred aspect, there is provided a filter unit used in a posture in which a gravity direction and a virtual plane extending along a filter intersect each other, the filter unit including the filter, a filter chamber that includes an upstream chamber and a downstream chamber separated by the filter, an inlet for introduction of liquid from an outside of the filter unit, and an outlet through which the liquid in the filter chamber flows out to the outside of the filter unit via the downstream chamber, in which the inlet is open in a second direction that intersects a first direction perpendicular to the virtual plane extending along the filter, the outlet is open in a third direction opposite to the second direction, and the inlet overlaps with the outlet as seen in the third direction. Accordingly, rotation can be performed with a line that links a portion at which the inlet is provided and a portion at which the outlet is provided to each other as a rotation axis. Therefore, the posture of the filter unit can be changed at the time of printing and at the time of maintenance. Accordingly, poor liquid supply or wasteful consumption of liquid can be suppressed at the time of printing, and the air bubble discharge performance can be improved at the time of maintenance.

In Aspect 2 which is a specific example of Aspect 1, a virtual center line that passes through a center of the inlet and that extends in the third direction passes through a center of the outlet. In this case, the filter unit is easily rotated with a line that links portions at which the inlet and the outlet are provided as a rotation axis.

In Aspect 3 which is a specific example of Aspect 1, the inlet overlaps with the filter chamber as seen in the third direction. In this case, the size of the filter unit can be reduced in the first direction in comparison with a case where the inlet does not overlap with the filter chamber, and thus the size of a space required for rotation of the filter unit can be reduced.

In Aspect 4 which is a specific example of Aspect 3, the inlet overlaps with the upstream chamber as seen in the third direction. In this case, since the inlet is disposed at a position at which the inlet overlaps with the upstream chamber of which the volume is larger than the volume of the downstream chamber so that a large number of air bubbles stay therein, the inlet can be formed in the same member as the upstream chamber and liquid leakage can be suppressed in comparison with a case where the inlet is formed by two members.

In Aspect 5 which is a specific example of Aspect 1, the filter unit further includes an outflow port through which the liquid flows out from the downstream chamber, and the outflow port is open in the first direction. In this case, air bubbles are easily discharged from the outflow port at the time of maintenance.

In Aspect 6 which is a specific example of Aspect 1, the inlet is disposed at a central portion of the filter unit in a direction orthogonal to the second direction. Accordingly, the size of a space for rotation of the filter unit can be reduced.

According to Aspect 7, which is a preferred aspect, there is provided a liquid ejecting apparatus including a liquid ejecting head that ejects liquid, a liquid storage portion that stores the liquid to be supplied to the liquid ejecting head, and the filter unit according to Aspect 1, the filter unit being disposed at an intermediate portion of a supply flow path for supply of the liquid from the liquid storage portion to the liquid ejecting head. In this case, the posture of the filter unit can be changed at the time of printing and at the time of maintenance. Accordingly, poor liquid supply or wasteful consumption of liquid can be suppressed at the time of printing, and the air bubble discharge performance can be improved at the time of maintenance.

In Aspect 8 which is a specific example of Aspect 7, the second direction is a direction intersecting the gravity direction.

According to Aspect 9, which is a preferred aspect, there is provided a maintenance method for a liquid ejecting head that includes a plurality of nozzles for ejection of liquid supplied from a filter chamber including an upstream chamber and a downstream chamber separated by a filter, the maintenance method including performing a printing operation in which the liquid ejecting head ejects the liquid to a medium with the filter chamber being in a first posture in which a lower surface of the filter that defines the downstream chamber faces a gravity direction and performing maintenance in which the liquid is discharged to an outside from the plurality of nozzles via the filter chamber with the filter chamber being in a second posture in which the lower surface faces a direction opposite to the gravity direction. Accordingly, poor liquid supply or wasteful consumption of liquid can be suppressed at the time of printing and the air bubble discharge performance can be improved at the time of maintenance by changing the posture of the filter chamber at the time of printing and at the time of maintenance.

What is claimed is:

1. A filter unit used in a posture in which a gravity direction and a virtual plane extending along a filter intersect each other, the filter unit comprising:
the filter;
a filter chamber including an upstream chamber and a downstream chamber separated by the filter;
an inlet for introduction of liquid from an outside of the filter unit; and
an outlet through which the liquid in the filter chamber flows out to the outside of the filter unit via the downstream chamber, wherein
the inlet is open in a second direction that intersects a first direction perpendicular to the virtual plane extending along the filter,
the outlet is open in a third direction opposite to the second direction, and
the inlet overlaps with the outlet as seen in the third direction.

2. The filter unit according to claim 1, wherein
a virtual center line that passes through a center of the inlet and that extends in the third direction passes through a center of the outlet.

3. The filter unit according to claim 1, wherein
the inlet overlaps with the filter chamber as seen in the third direction.

4. The filter unit according to claim 3, wherein
the inlet overlaps with the upstream chamber as seen in the third direction.

5. The filter unit according to claim 1, further comprising:
an outflow port through which the liquid flows out from the downstream chamber, wherein
the outflow port is open in the first direction.

6. The filter unit according to claim 1, wherein
the inlet is disposed at a central portion of the filter unit in a direction orthogonal to the second direction.

7. A liquid ejecting apparatus comprising:
a liquid ejecting head configured to eject liquid;
a liquid storage portion that stores the liquid to be supplied to the liquid ejecting head; and
the filter unit according to claim 1, the filter unit being disposed at an intermediate portion of a supply flow path for supply of the liquid from the liquid storage portion to the liquid ejecting head.

8. The liquid ejecting apparatus according to claim 7, wherein
the second direction is a direction intersecting the gravity direction.

9. A maintenance method for a liquid ejecting head that includes a plurality of nozzles for ejection of liquid supplied from a filter chamber including an upstream chamber and a downstream chamber separated by a filter, the maintenance method comprising:
performing a printing operation in which the liquid ejecting head ejects the liquid to a medium with the filter chamber being in a first posture in which a lower surface of the filter that defines the downstream chamber faces a gravity direction; and
performing maintenance in which the liquid is discharged to an outside from the plurality of nozzles via the filter chamber with the filter chamber being in a second posture in which the lower surface faces a direction opposite to the gravity direction.
